(19) United States
(12) Patent Application Publication
(10) Pub. No.: US 2018/0075552 A1
(43) Pub. Date: Mar. 15, 2018

(54) SMART OPEN HOUSE SYSTEM AND METHOD

(71) Applicant: Babak Mehranvar, Toronto (CA)

(72) Inventor: Babak Mehranvar, Toronto (CA)

(21) Appl. No.: 15/266,548

(22) Filed: Sep. 15, 2016

(51) Int. Cl. G06Q 50/16; G06Q 30/06; G01S 19/42

(52) U.S. Cl. CPC G06Q 50/16; G06Q 30/0623; G01S 19/42; G06Q 30/0639; G06Q 30/0643

(57) ABSTRACT

A smart open house system for providing a mobile device application useful for identifying and viewing the details and location of at least one real estate listing. The user interface may be a real estate multiple listing service interface, a global positioning system module, and a user-input interface. The interface to the real estate multiple listing database may include a search module for creating a user-initiated query to locate at least one real estate listing or at least one open house listing. The global positioning system module may also provide access to the stationary and moving location of both the user's the mobile device and the map display useful for guiding a user the real estate listing or open house listing. The user-input interface may further include user-defined search criteria and a note-taking module for a user to document observations.

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of information services and more specifically relates to a searchable mobile device applications.

### 2. DESCRIPTION OF RELATED ART

Buying a new home or property is a big decision with many variables such as the asking price, the location, the size of the home, the neighborhood, the school district, and so on. When looking for a new home or property, a person may look on-line at websites showing homes for sale, but often a person may wish to view the home or property in person. Open houses are a good way for a person to take a first look at a home or property. The primary way to find an open house is to locate signs on street corners and then attempt to follow the signs to the home or property. If the person is lucky, they may have previewed the home or property at home on the computer before finding the open house signs. Unless the person has a list of open houses, they have to find another home or property listing and search to find an open house for it. A suitable solution is desired.

Several attempts have been made to solve the above-mentioned problems such as those found in U.S. Pat. and Pub. Nos. 8,346,796 to Kardell; 2012/0290203 to King; 2013/0132290 to Binnings; 2014/0304178 to Benson, et al.; 2004/0030631 to Brown, et al.; and 2011/0301987 to Wiese. This art is representative of searchable mobile device applications. However, none of the above inventions and patents, taken either singly or in combination, is seen to describe the invention as claimed.

### BRIEF SUMMARY OF THE INVENTION

In view of the foregoing disadvantages inherent in the known searchable mobile device application art, the present invention provides a novel smart open house system. The general purpose of the present invention, which will be described subsequently in greater detail is to provide an application to search for and view details of real estate listings and open houses.

A smart open house system is disclosed herein, in a preferred embodiment, comprising the smart open house mobile device application. The smart open house mobile device application may comprise in structural and functional combination a software application useful for a user to identify the details of at least one real estate listing, identify a location of the at least one real estate listing, view details of the at least one real estate listing, and locate the at least one real estate listing on a map display. Further, the smart open house mobile device application may comprise a user interface. The user interface may comprise a real estate multiple listing service interface, a global positioning system module, and a user-input interface.

The real estate multiple listing service interface may comprise access to the real estate multiple listing database. In addition, the interface to the real estate multiple listing database may comprise a search module, useful for creating a user-initiated query to locate at least one real estate listing and alternatively at least one open house listing. The interface to the real estate multiple listing database may provide details of the at least one real estate listing, useful for display of a location of the at least one real estate listing, listed price, and information to include at least the lot size, property size, property square footage, number of bedrooms, number of bathrooms, and number of parking spaces. The interface to the real estate multiple listing database may further comprise a first-link to the map display, useful for displaying the location of the at least one real estate listing in a predetermined geographical area.

The global positioning system module may also comprise access to the stationary and alternatively the moving location of both the user's the mobile device and the map display useful for guiding a user to at least one real estate listing and alternatively at least one open house listing. Further, the at least one open house listing may comprise the location of the at least one real estate listing, the date, and the hours for at least one open house listing. The at least one open house listing may further comprise a second-link to the map display, useful for displaying the location of the at least one open house listing in the predetermined geographical area.

The user-input interface may comprise tactile input for a mobile device touchscreen. The user-input interface may further comprise user-defined search criteria. The user-defined search criteria may comprise an interface for user input of criteria for the location of the at least one real estate listing, desired price, and the desired details to include at least the lot size, the property size, the property square footage, the number of bedrooms, the number of bathrooms, and the number of parking spaces. The user-input interface may further comprise a note-taking module. The note-taking module may comprise a virtual notepad for a user to document observations as desired. The observations of the note-taking module may comprise a third-link to the at least one real estate listing of the real estate multiple listing database, useful for ready recollection of the at least one real estate listing and the observations of the at least one real estate listing. The note-taking module may further comprise options to edit, save, and delete the observations as desired.

The smart open house system further may comprise a kit including: the smart open house mobile device application, and a set of user instructions.

A method for using a smart open house system is also disclosed herein. The method for providing a smart open house system includes the steps of: step one, accessing a smart open house mobile device application from a mobile device; step two, searching a real estate multiple listing database to locate to locate at least one real estate listing and alternatively at least one open house listing; step three, linking the at least one real estate listing and alternatively the at least one open house listing to a map display to view the at least one real estate listing and alternatively the at least one open house listing in a predetermined geographical area; step four, navigating to the at least one real estate listing and alternatively to the at least one open house listing using the map display; and step five, documenting observations in a note-taking module. The method of use further may comprise the steps of saving, editing, and deleting options for the observations in the note-taking module as desired.

The present invention holds significant improvements and serves as a smart open house system. Preferably, a searchable mobile device application should provide an application to search for and view details of real estate listings and open houses and, yet would operate reliably and be manufactured at a modest expense. Thus, a need exists for a reliable smart open house system to avoid the above-mentioned problems.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present disclosure, smart open house system, constructed and operative according to the teachings of the present disclosure.

FIG. 1 shows a perspective view illustrating a smart open house system during an ‘in-use’ condition according to an embodiment of the disclosure.

FIG. 2 is a perspective view illustrating the smart open house system comprising a smart open house system application according to an embodiment of the present invention of the disclosure.

FIG. 3 is a perspective view illustrating the smart open house system application according to an embodiment of the present disclosure.

FIG. 4 is a perspective view illustrating the smart open house system application according to an embodiment of the present disclosure.

FIG. 5 is a flow diagram illustrating a method of use for the smart open house system application according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a searchable mobile device application and more particularly to a smart open house system as used to improve the applications to search for and view details of real estate listings and open houses.

Generally speaking, potential real estate buyers typically follow open house signs and get lost or get distracted with other signs. With this application, real estate buyers will be directed to the closest open house and also get all important information pertaining to the house. Once they are done viewing the house, they can leave themselves comments for future reference and then be directed to the next closest open house that meets their criteria. GPS navigation to the closest open houses is provided based on search criteria, all important information regarding house is shown for immediate viewing, and all locations and notes are tracked and recorded for future reference.

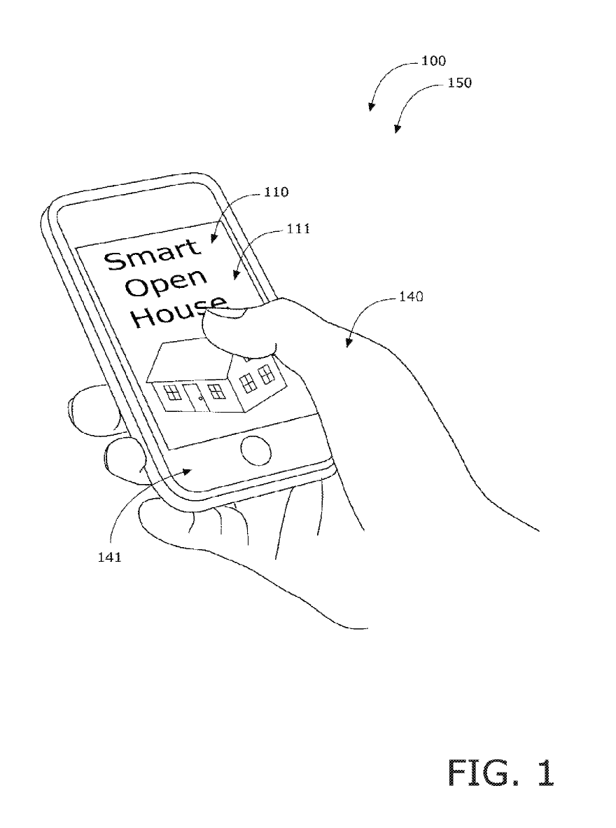

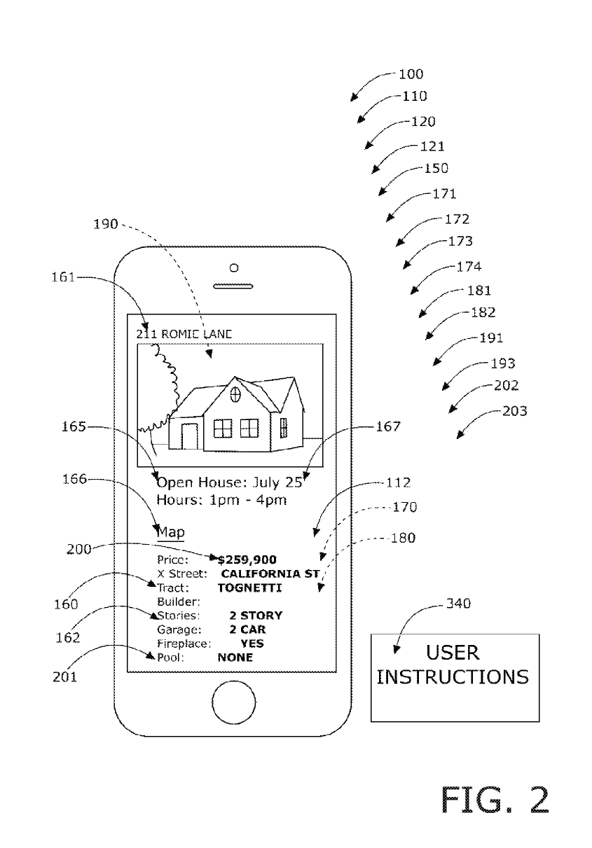

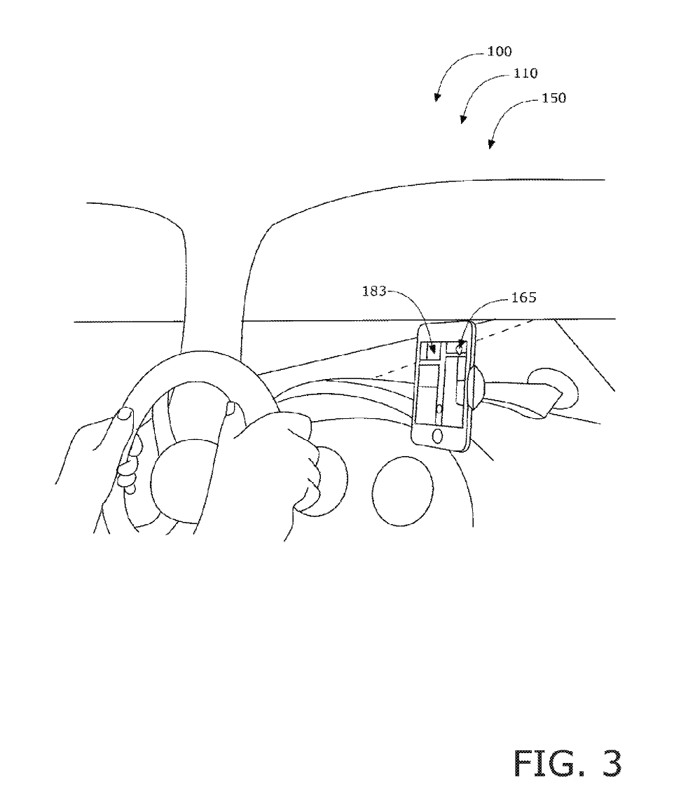

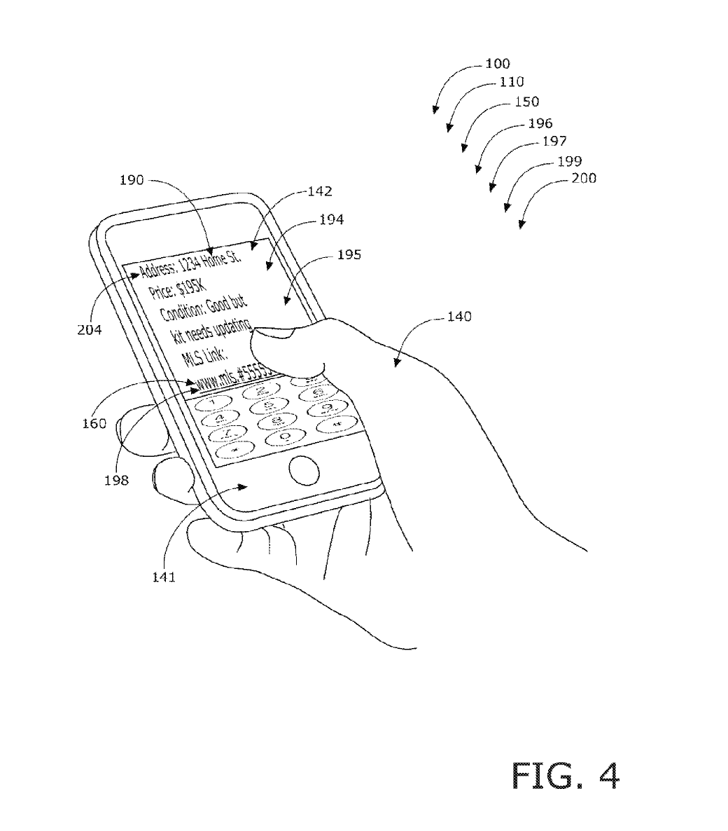

Referring now more specifically to the drawings by numerals of reference there is shown in FIGS. 1-4, various views of smart open house system 100. Smart open house system 100 may comprise smart open house mobile device application 110 (FIG. 1). Smart open house mobile device application 110 may comprise in structural and functional combination a software application 111 useful for user 140, during an ‘in-use’ condition 150, to identify details of at least one real estate listing 160 (FIG. 2), identify a location of the at least one real estate listing 161, view details of the at least one real estate listing 162, locate the at least one real estate listing 160 on map display 183 (FIG. 3), and access the user-input interface 190 (FIG. 4).

Smart open house mobile device application 110 may comprise user interface 112. User interface 112 may comprise real estate multiple listing service interface 170, global positioning system module 180, and user-input interface 190 (FIG. 4). Global positioning system module 180 may comprise access to stationary 181 and alternatively moving location 182 of mobile device 141 and map display 183, useful for guiding user 140 to location of at least one real estate listing 161 and alternatively at least one open house listing 165. In another embodiment of the present invention, smart open house mobile device application 110 may comprise web-based application 120, useful for accessing smart open house mobile device application 110 from a computing device 121.

In further referring to FIGS. 1-4, real estate multiple listing service interface 170 may comprise access to real estate multiple listing database 171. Real estate multiple listing database interface 171 may comprise search module 172, useful for performing a user-initiated query 173 to locate at least one real estate listing 160 and alternatively at least one open house listing 165. Interface to the real estate multiple listing database 171 may provide details of at least one real estate listing 162, useful for display of a location of at least one real estate listing 161, listed price 200, and information 201 to include at least lot size, property size, property square footage, number of bedrooms, number of bathrooms, and number of parking spaces.

User 140 may be able to select and review additional information 201 such as home amenities such as a pool or a fireplace, and neighborhood information such as parks and recreation and school district information. Real estate multiple listing database interface 171 may further comprise first-link 174 to map display 183, useful for displaying location of at least one real estate listing 161 in a predetermined geographical area. Further, at least one open house listing 165 may comprise location of at least one real estate listing 161, date and hours 167 for at least one open house listing 165. At least one open house listing 165 may additionally comprise second-link 166 to map display 183, useful for displaying location of at least one open house listing 165 in predetermined geographical area.

User-input interface 190 may comprise tactile input 142 for mobile device 141 touchscreen. Further, user-input interface 190 (FIG. 2) may comprise user-defined search criteria 191. User-defined search criteria 191 may comprise interface 193 for user input of criteria 193 for location of at least one real estate listing 161, and alternatively at least one open house listing 165, desired price 202, and desired details 203 to include at least lot size, property size, property square footage, number of bedrooms, number of bathrooms, and number of parking spaces.

User-input interface 190 may further comprise note-taking module 194 (FIG. 4). Note-taking module 194 may comprise virtual notepad 195 for user 140 to document observations 204 as desired. Further, note-taking module 194 may comprise audio recorder 196 for user 140 to create audio recording 197 of observations 204 as desired. Virtual notepad 195 of note-taking module 194 may comprise third-link 198 to at least one real estate listing 160 of real estate multiple listing database 171, useful for ready recollection of at least one real estate listing 160 and observations 204 of at least one real estate listing 160. Further, note-taking module 194 may comprise options 199 to edit, save, and delete observations 204 as desired.

The smart open house system 100 may be sold as a kit comprising the following parts: at least one smart open house mobile device application 110; and at least one set of user instructions 340. The kit has instructions such that functional relationships are detailed in relation to the structure of the invention (such that the invention can be used, maintained, or the like in a preferred manner).

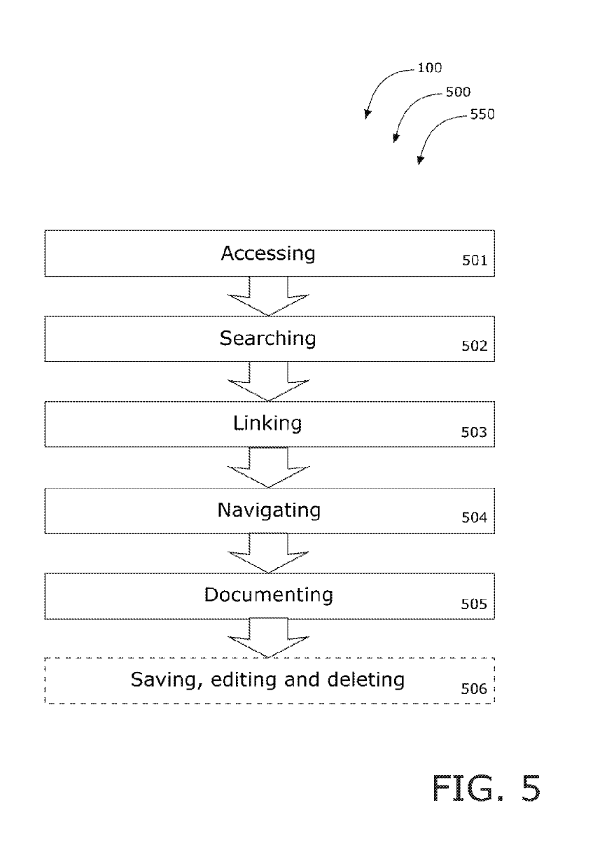

Referring now to FIG. 5 showing a flow diagram 550 illustrating method of use 500 for smart open house system 100 according to an embodiment of the present invention of FIGS. 1-4.

As shown, method of use 500 may comprise the steps of: step one 501, accessing a smart open house mobile device application 110 from a mobile device 141 and alternatively a computing device 121; step two 502, searching a real estate multiple listing database 171 to locate to locate at least one real estate listing 160 and alternatively at least one open house listing 165; step three 503, linking the at least one real estate listing 160 and alternatively the at least one open house listing 165 to a map display 183 to view the at least one real estate listing 160 and alternatively the at least one open house listing 165 in a predetermined geographical area; step four 504, navigating to the at least one real estate listing 160 and alternatively the at least one open house listing 165 using the map display 183; step five 505, documenting observations 204 in a note-taking module 194; and step six 506, saving, editing, and deleting options 199 for observations 204 in the note-taking module 194 as desired.

It should be noted that step 506 is an optional step and may not be implemented in all cases. Optional steps of method of use 500 are illustrated using dotted lines in FIG. 5 so as to distinguish them from the other steps of method of use 500.

It should be noted that the steps described in the method of use can be carried out in many different orders according to user preference. The use of “step of” should not be interpreted as “step for”, in the claims herein and is not intended to invoke the provisions of 35 U.S.C. § 112 (f). Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A smart open house system comprising:
a smart open house mobile device application comprising;
a user interface comprising;
a real estate multiple listing service interface;
a global positioning system module comprising;
access to a stationary and alternatively a moving location of a mobile device;
a map display; and
a user-input interface;
wherein said smart open house system comprises said smart open house mobile device application;
wherein said smart open house mobile device application comprises said user interface;
wherein said user interface comprises said real estate multiple listing service interface, said global positioning system module, and said user-input interface;
wherein said global positioning system module comprises said access to said stationary and alternatively said moving location of said mobile device and said map display; and
wherein said smart open house mobile device application comprises in structural and functional combination a software application useful for a user to identify details of at least one real estate listing, identify a location of said at least one real estate listing, view details of said at least one real estate listing, locate said at least one real estate listing on said map display, and access said user-input interface.

2. The smart open house system of claim 1 wherein said smart open house mobile device application comprises a web-based application, useful for accessing said smart open house mobile device application from a computing device.

3. The smart open house system of claim 1 wherein said real estate multiple listing service interface comprises access to a real estate multiple listing database.

4. The smart open house system of claim 3 wherein said interface to said real estate multiple listing database comprises a search module, useful for a user-initiated query to locate said at least one real estate listing and alternatively at least one open house listing.

5. The smart open house system of claim 3 wherein said interface to said real estate multiple listing database comprises providing details of said at least one real estate listing, useful for display of a location of said at least one real estate listing, listed price, and information to include at least lot size, property size, property square footage, number of bedrooms, number of bathrooms, and number of parking spaces.

6. The smart open house system of claim 4 wherein said at least one open house listing comprises a location of at least one real estate listing, date, and hours for said at least one open house listing.

7. The smart open house system of claim 3 wherein said interface to said real estate multiple listing database comprises a first-link to said map display, useful for displaying said location of at least one real estate listing in a predetermined geographical area.

8. The smart open house system of claim 1 wherein said at least one open house listing comprises a second-link to said map display, useful for displaying said location of at least one open house listing in said predetermined geographical area.

9. The smart open house system of claim 1 wherein said user-input interface comprises tactile input for a mobile device touchscreen.

10. The smart open house system of claim 9 wherein said user-input interface comprises user-defined search criteria.

11. The smart open house system of claim 10 wherein said user-defined search criteria comprises an interface for user input of criteria for said location of at least one real estate listing, desired price, and desired details to include at least said lot size, said property size, said property square footage, said number of bedrooms, said number of bathrooms, and said number of parking spaces.

12. The smart open house system of claim 9 wherein said user-input interface comprises a note-taking module.

13. The smart open house system of claim 12 wherein said note-taking module comprises a virtual notepad for said user to document observations as desired.

14. The smart open house system of claim 13 wherein said note-taking module comprises an audio recorder for said user to create an audio recording of said observations as desired.

15. The smart open house system of claim 13 wherein said observations of said note-taking module comprises a third-link to said at least one real estate listing of said real estate multiple listing database, useful for ready recollection of said at least one real estate listing and said observations of said at least one real estate listing.

16. The smart open house system of claim 12 wherein said note-taking module comprises options to edit, save, and delete said observations as desired.

17. A smart open house system comprising:
a smart open house mobile device application comprising;
a user interface comprising;
a real estate multiple listing service interface;
a global positioning system module comprising;
access to a stationary and alternatively a moving location of a mobile device;
a map display; and
a user-input interface;
wherein said smart open house system comprises said smart open house mobile device application;
wherein said smart open house mobile device application comprises said user interface;
wherein said user interface comprises said real estate multiple listing service interface, said global positioning system module, and said user-input interface;
wherein said global position system module comprises said access to said stationary and alternatively said moving location of said mobile device and said map display;
wherein said smart open house mobile device application comprises a web-based application, useful for accessing said smart open house mobile device application from a computing device;
wherein said real estate multiple listing service interface comprises access to said real estate multiple listing database;
wherein said interface to said real estate multiple listing database comprises a search module, useful for a user-initiated query to locate said at least one real estate listings and alternatively at least one open house listings;
wherein said interface to said real estate multiple listing database comprises providing details of said at least one real estate listing, useful for display of a location of said at least one real estate listing, listed price, and details to include at least lot size, property size, property square footage, number of bedrooms, number of bathrooms, and number of parking spaces;
wherein said at least one open house listings comprise location of at least one real estate listing, date, and hours for said at least one open house listings;
wherein said interface to said real estate multiple listing database comprises a first-link to said map display, useful for displaying said location of said at least one real estate listings in a predetermined geographical area;
wherein said at least one open house listing comprises a second-link to said map display, useful for displaying said location of said at least one open house listings in said predetermined geographical area;
wherein said user-input interface comprises tactile input for a mobile device touchscreen;
wherein said user-input interface comprises user-defined search criteria;
wherein said user-defined search criteria comprises an interface for user input of criteria for said location of said at least one real estate listing, desired price, and said desired details to include at least said lot size, said property size, said property square footage, said number of bedrooms, said number of bathrooms, and said number of parking spaces;
wherein said user-input interface comprises a note-taking module;
wherein said note-taking module comprises a virtual notepad for a user to document observations as desired;
wherein said note-taking module comprises an audio recorder for a user to create an audio recording of observations as desired;
wherein said user-defined details of said note-taking module comprises a third-link to said at least one real estate listing of said real estate multiple listing database, useful for ready recollection of said at least one real estate listing and said observations of said at least one real estate listing;
wherein said note-taking module comprises options to edit, save, and delete user-defined details as desired; and
wherein said smart open house mobile device application comprises in structural and functional combination a software application useful for a user to identify details of a at least one real estate listing, identify a location of said at least one real estate listing, view details of said at least one real estate listing, locate said at least one real estate listing on said map display, and access said user-input interface.

18. The smart open house system of claim 17 further comprising a kit including:
said smart open house mobile device application; and
a set of user instructions.

19. A method of using a smart open house system comprising the steps of:
accessing a smart open house mobile device application from a mobile device and alternatively a computing device;
searching a real estate multiple listing database to locate to locate real estate listings and alternatively at least one open house listings;
linking said real estate listings and alternatively said at least one open house listings to a map display to view said real estate listings and alternatively said at least one open house listings in a predetermined geographical area;
navigating to said real estate listings and alternatively said at least one open house listings using said map display; and
documenting user-defined details in a note-taking module

20. The method of claim 19 further comprising the steps of saving, editing, and deleting said user-defined details in said note-taking module as desired.
